(19) United States
(12) Patent Application Publication
(10) Pub. No.: US 2010/0223806 A1
(43) Pub. Date: Sep. 9, 2010

(54) BURNER, INSTALLATION AND METHOD FOR DRYING DIVIDED PRODUCTS USING SUCH A BURNER

(76) Inventors: Christian Labarde, Aunay Sous Crecy (FR); Franck Beaumont, Saint Rimay (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/703,317

(22) Filed: Feb. 10, 2010

(30) Foreign Application Priority Data
Feb. 18, 2009 (FR) FR 0951065

(51) Int. Cl. F26B 3/02; B05B 7/10; F26B 21/00; D06F 58/04

(52) U.S. Cl. 34/499; 239/399; 34/79; 34/130

(57) ABSTRACT

A burner for burning substances, in particular uncondensed offgas from a condenser of a drying installation, is intended to be fed with fuel, oxidizer and substances to be burned. The burner includes an axial feed inlet for feeding the burner with offgas and a set of fuel injection nozzles distributed around the axial feed inlet.

### BACKGROUND OF THE INVENTION

1. Field of the Invention

The invention relates in general to installations for drying divided products, for example divided products issuing from the sugar industry or issuing from the distillation of starch products (wheat, etc.) or beets or even from the wood industry.

2. Description of the Relevant Art

The drying requirements of industries such as the sugar industry, wood industry, and starch product distillation industries are increasingly urgent.

For example, the processing carried out in industrial installations generates solid waste, designated by the term “pulp” in a sugar beet refinery or “husks” in distillation, which are generally intended to be used in the form of granules for animal feed and which must be dried for storage. This is also the case of alfalfa, intended for animal feed.

The drying is generally carried out in a dryer, for example a drum dryer, in which the heat is supplied by a drying gas previously heated in a furnace provided with a burner.

Drying is an important energy item in sugar refineries and in distillation units.

However, apart from the energy aspect, the drying methods employed in drying installations are liable to create environmental problems, insofar as their implementation causes the emission of odors, dust and pollutants.

Attempts have been made to overcome this drawback by recovering the drying gases at the dryer outlet and by using them as oxidizing air input for the burner.

In this respect, reference can be made to document EP B 0 457 203 which describes an installation and a method for drying a substance in a drum dryer and in which, downstream of the drum dryer, a separation device is used to recover, on the one hand, the dry substances and, on the other hand, an essentially gaseous fraction whereof part is intended to be heated and reinjected at the drum dryer inlet and whereof another part is partially reinjected as oxidizer in a combustion chamber dedicated to heating the drying gases.

The use of this fraction as oxidizer comprises the following drawbacks in particular:
a low flame temperature, due to the presence of water vapor, with the risk of being too low to destroy the undesirable compounds; and
a risk for the safety of the burner, because the oxidizer/fuel ratio is difficult to control.

### SUMMARY OF THE INVENTION

Embodiments described herein overcome the drawbacks of the prior art by permitting the combustion of the substances or compounds present in the gases issuing from a drum dryer at a higher temperature capable of destroying all these products or compounds and also the odors liable to be released during the operation of a drying installation.

According to a first aspect, a burner is described for destroying substances, in particular uncondensed offgas from a condenser of a drying installation, the said burner being intended to be fed with fuel, oxidizer and substances to be burned.

The burner includes an axial feed inlet for feeding the burner with offgas and a set of fuel injection nozzles distributed around the axial feed inlet.

Thanks to this arrangement, it is possible to inject the uncondensed offgas at the center of the flame, that is at a very high temperature.

Thanks to this arrangement, the gases recovered at the dryer outlet, and in particular the uncondensable fraction of these gases, can be burned at a temperature above 1000° C., thereby removing all the compounds, including the volatile organic compounds or VOCs, the CO and the odors.

According to another feature of the burner, it further includes means for imparting an axial swirl motion to the offgas.

The combustion of the offgas is thereby significantly improved by promoting heat exchanges.

In one embodiment, the means for imparting a swirl motion to the offgas include a set of radial fins disposed at the feed inlet.

According to a further feature, the burner includes a substantially frustoconical inlet portion whereof the apex is located near the feed inlet, the said frustoconical portion including means for feeding the burner with oxidizer.

According to a second aspect, an installation for drying divided products, in particular distillation products, includes a drum dryer receiving, at the inlet, the divided products to be dried and fed with drying gas heated by means of a furnace combined with a heat exchanger, a separation device for recovering the dried products and the drying gases at the dryer outlet, and means for condensing the drying gas.

The furnace includes a burner as defined above, fed with uncondensed offgas issuing from the condensing means so that, in operation, the said offgas is injected at the center of a flame maintained in the furnace.

Advantageously, the temperature of the offgas injection zone is at least 1000° C.

In one embodiment, this installation includes a distribution device which communicates with the heat exchanger, on the one hand, and with the condensing means, on the other hand, the distribution device being suitable for distributing the gases issuing from the drum dryer between the condensing means, on the one hand, and the dryer, by passing through the heat exchanger, on the other hand.

This installation may also further include means for feeding dilution gas for lowering the temperature of the furnace.

The temperature of the gases at the furnace outlet can then be lowered, before introduction into the heat exchanger, in order to protect it from an excessively high temperature that would damage its structure.

Preferably, the means for feeding dilution gas includes a coupling disposed near the outlet of the furnace.

The installation may further include a stage for scrubbing the drying gases, disposed upstream of the condensing means.

In one embodiment, the installation may further include means for feeding the burner with oxidizer suitable for taking ambient air, by passing it through a heat exchanger.

It may further include a second duct for taking part of the offgas from the installation to supply the furnace of the burner with dilution gas for lowering the furnace outlet temperature.

For example, the condensing means includes a secondary heat recovery circuit. This circuit is intended to use the heat collected by the condensing means.

The circuit in which the gases issuing from the dryer flow may include means for maintaining the circuit under negative pressure.

According to a third aspect, a method for drying divided products, in particular distillery products, includes:
drying the divided products to be dried by means of a drum dryer fed with drying gas heated by means of a burner combined with a heat exchanger;
separating the dried products and the drying gases at the dryer outlet; and
condensing the drying gases and injecting the uncondensed offgas into the center of a flame maintained in the furnace.

### BRIEF DESCRIPTION OF THE DRAWINGS

Other aims, features and advantages of the invention will appear from a reading of the following description, provided exclusively as a non-limiting example, with reference to the appended drawings in which:

FIG. 1 is a block diagram showing the general architecture of a drying installation according to the invention;

FIG. 2 is a perspective view of a burner of the installation in FIG. 1; and

FIG. 3 is a front view of the burner in FIG. 2.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

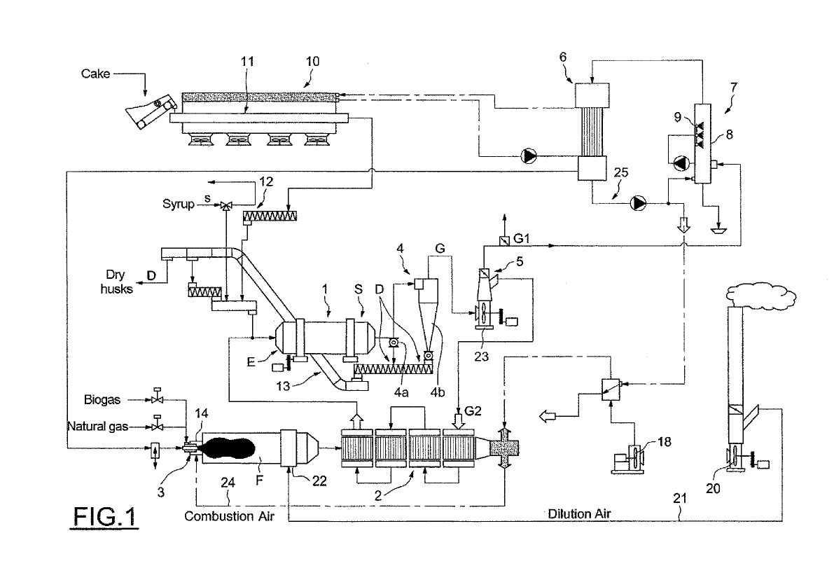

FIG. 1 shows schematically the general architecture of an installation for drying substances.

In the application considered, this installation is intended for drying distillation by-products, starch products, wheat or similar, or products issuing from sugar beet refineries or beet-distilling installations.

As this figure shows, the installation is based on the use of a drum dryer 1 which receives, at the inlet E, wet husks supplied to it in the form of a cake and which delivers, at the outlet S, dry husks D and gases G which, after heating by means of a heat exchanger 2, are partly intended to be reinjected as heating gas at the inlet of the drum dryer 1.

Thus, in addition to the dryer 1 and the heat exchanger 2, the installation includes: a furnace F provided with a burner 3 and serving to feed the heat exchanger 2, with hot gases; a separation device 4 including a seal 4a at the outlet of the dryer 1 and a cyclone 4b, serving to separate the dry husks D from the gases G at the outlet S of the dryer 1; a distributor 5 for distributing the gas fraction G issuing from the main separator 4, between a first gas fraction G1 and a second fraction G2 which is supplied to the heat exchanger 2; and a condenser 6 for condensing the first gas fraction G1 issuing from the distributor 5 and wherefrom condensates 25 issue.

FIG. 1 also shows that the installation is supplemented by a scrubbing device 7 placed upstream of the condenser and serving to scrub the fraction G1 of the drying gases in order, in particular, to roughly trap the substances conveyed.

For example, this scrubbing device 7 includes a chamber 8 provided with a set of nozzles, such as 9, spraying a wall of water on the path of the gases and thereby causing the particles to be sprayed against the walls of the chamber 8 before being removed at the outlet.

The installation further includes a system 10 for feeding the dryer 1 with wet husks. This system 10 includes a belt conveyor 11 which incorporates an air stream heated by a secondary hot water circuit heated in the condenser 6 by partial condensation of the first fraction G1, in order thereby to predry the cake fed to it.

Downstream of the feed system 10, the installation includes a set of conveyors, such as 12, for transferring the wet husks to the dryer 1.

However, it should be observed that, upstream of the dryer 1, the husks are mixed with a syrup s prepared for example by concentrating clarified slops, themselves obtained for example by physical separation, particularly by centrifugation, of the slops collected as bottoms from the distillation column.

At the outlet of the dryer 1, a transfer conveyor 13 recovers the dry husks issuing from the separator 4 so that they can be used subsequently for animal feed in the form of granules.

As to the drying gases, as stated above, the first gas fraction G1 issuing from the distributor 5 is intended, by condensing, to constitute a source of hot water which can be used to supply all types of devices or installations requiring a hot water input.

Thus, as shown in FIG. 1, the condensation can be used to heat a secondary water circuit for predrying the cake in the feed system 10.

Part of the condensates 25 may also be used for the prior scrubbing of the first gas fraction G1 in the scrubbing device 7.

However, the condensates 25 may also be used for any other application requiring a source of hot water, for example, as shown, for preheating the oxidizer taken from the exterior.

As to the second gas fraction issuing from the distributor 5, it is intended to be reintroduced in a closed circuit at the inlet E of the dryer 1, after heating in the heat exchanger 2.

The heating gases of heat exchanger 2 are delivered by the furnace F at the entry whereof the burner 3 is placed. The furnace is fed on the one hand with fuel, for example natural gas, or biogas, and with oxidizer taken from the exterior and previously heated, by heat exchange at the outlet of the heat exchanger 2.

The furnace F also has the function of burning the uncondensed offgas from the fraction G1 of the heating gases separated at the outlet of the dryer 1.

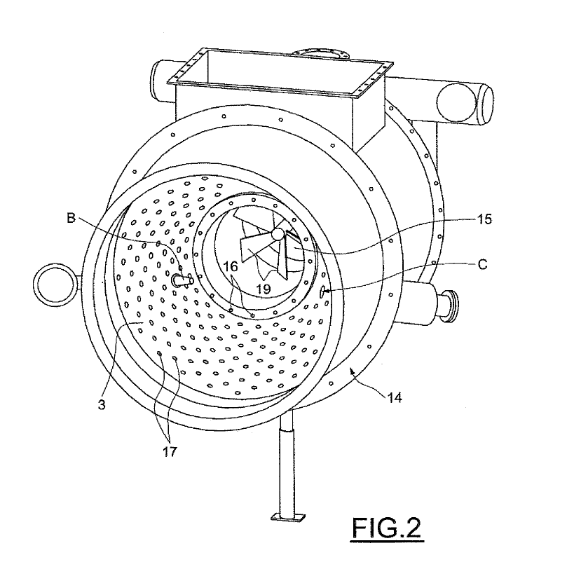

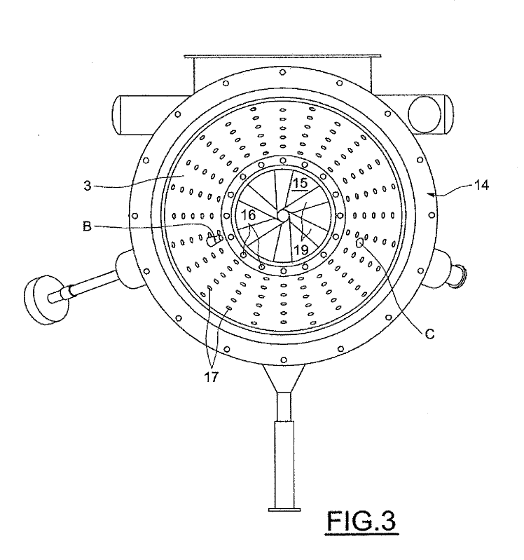

With reference also to FIGS. 2 and 3, the burner 3 includes a chamber 14 which includes an axial passage 15 through which the uncondensed gas fraction G1 issuing from the condenser 6 and which contains compounds to be destroyed (CO, VOCs, etc.) is introduced, along with a set of injection nozzles 16 oriented coaxially with the passage 15 and uniformly distributed about this passage 15. Downstream, in the flow direction of the uncondensed particles in the burner 3, the said burner includes a frustoconical portion connected via its apex to the passage 15 and drilled with orifices, such as 17, uniformly distributed throughout the conical portion for feeding the burner with oxidizer taken from the exterior by means of a fan 18 taking ambient air combined with a duct 24 terminating in the burner 3 and passing through a heat exchanger. This conical portion is also provided with a pilot burner B and a flame detection cell C opposite.

It should be observed in this respect that, as mentioned above, the oxidizer is preheated on the one hand by the condensates 25, and on the other hand by the combustion gases leaving the heat exchanger 2, by means of an additional module at the heat exchanger outlet.

This heating of the oxidizer taken from the exterior contributes to obtaining a high flame temperature.

As shown in FIGS. 2 and 3, the feed passage 15 is provided with means for imparting an axial swirl motion to the incident particles. For example, these means are arranged in the form of a set of fixed radial fins 19 disposed in the passage 15, here six in number as an example.

As may be observed, thanks to this arrangement, in operation, the burner emits a nosecone-shaped flame, the uncondensed offgas being injected directly into the center of the flame at a very high temperature, that is at a temperature above 1000° C.

It has been found that in operation, these particles were burned in the furnace in a period of about two seconds, and this, combined with the high flame temperature and the swirl motion, ensures complete combustion of all the offgas, in particular the VOCs and the CO.

As stated above, at the furnace outlet, the hot gases are used to heat the fraction G2 of the heating gases by means of the heat exchanger 2. Downstream of this heat exchanger, the heating gases issuing from the furnace are extracted by an extractor 20 to be removed to the exterior, free of particles and of odors. However, a fraction of these gases is recovered and reinjected near the outlet of the furnace F by means of a duct 21 and a coupling 22, as dilution gas for lowering the temperature of the gases delivered at the outlet of the furnace to the heat exchanger.

The coupling 22 is in this respect preferably disposed near the furnace outlet or, at all events, at a distance from the nozzles for injecting fuel into the burner, in order to avoid cooling the flame.

This prevents damage to the heat exchanger by excessively high temperatures, while avoiding disturbing the temperature of the flame in which the uncondensed offgas is burned.

Furthermore, the overall circuit in which the heating gases flow, and in particular the fraction G2 of the heating gases, constitutes a virtually closed circuit. These gases are set in motion under the action of a fan 23 provided at the secondary separation device 5.

It has been found that the execution of this closed circuit serves to prevent the intake of additional air, to limit the amount of air entering at the junctions of the dryer 1 and, in particular, to obtain a dew point above 90° C., and in particular of about 95° C., which has the advantage, on the one hand, of allowing for a high condensation yield in the condenser 6 and, on the other hand, of ensuring a low oxygen content in the virtually closed circuit (lower than 10% by volume expressed as wet gas), thereby keeping the circuit outside its inflammability range.

It should also be observed that the limitation of the amount of air entering the junctions contributes to obtaining a high flame temperature.

It should further be noted that the burner described above is self-contained in terms of oxidizer.

It should finally be noted that the use of a burner for injecting species such as CO or VOCs, in the flame, is independent of the use of other elements of the installation, and in particular of the condenser, of the gas scrubbing device, and of the feed device 10, so that such elements could also be used, alone or in combination, independently of the burner described above.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Burner for destroying substances, in particular uncondensed offgas from a condenser of a drying installation, the said burner being intended to be fed with fuel, oxidizer and substances to be burned, comprising an axial feed inlet for feeding the burner with offgas and a set of fuel injection nozzles distributed around the axial feed inlet.

2. Burner according to claim 1, further comprising means for imparting an axial swirl motion to the offgas.

3. Burner according to claim 2, wherein the means for imparting a swirl motion to the offgas comprises a set of radial fins disposed at the feed inlet.

4. Burner according to claim 1, further comprising a substantially frustoconical inlet portion wherein an apex of the frustoconical inlet portion is located near the feed inlet, the said frustoconical portion comprising means for feeding the burner with oxidizer.

5. Installation for drying divided products, in particular distillation products, comprising:
a drum dryer receiving, at the inlet, the divided products to be dried and fed with drying gas heated by means of a furnace combined with a heat exchanger;
a primary separation device for separating the dried products and the drying gases at the dryer outlet; and
condensing means fed with drying gas,
wherein the furnace comprises a burner according to claim 1, fed with uncondensed offgas issuing from the condensing means so that, in operation, the said offgas is injected at the center of a flame maintained in the furnace.

6. Installation according to claim 5, wherein the temperature of the offgas injection zone is at least 1000° C.

7. Installation according to claim 5, further comprising a distribution device which communicates with the heat exchanger, and with the condensing means, and which is suitable for distributing the gases issuing from the drum dryer between the condensing means and the dryer, by passing through the heat exchanger.

8. Installation according to claim 5, further comprising means for feeding dilution gas for lowering the temperature of the furnace.

9. Installation according to claim 8, wherein the means for feeding dilution gas comprise a coupling disposed near the outlet of the furnace.

10. Installation according to claim 5, further comprising a stage for scrubbing the drying gases, disposed upstream of the condensing means.

11. Installation according to claim 7, further comprising means for feeding the burner with oxidizer suitable for taking ambient air, by passing it through a heat exchanger.

12. Installation according to claim 7, further comprising a second duct for taking part of the offgas from the installation to supply the furnace with dilution gas for lowering the furnace outlet temperature.

13. Installation according to claim 7, wherein the condensing means comprise a secondary heat recovery circuit.

14. Installation according to claim 7, wherein the circuit in which the gases issuing from the dryer flow comprises means for setting the gases in motion.

15. Method for drying divided products, in particular distillery products, comprising:
drying the divided products to be dried by means of a drum dryer fed with drying gas heated by means of a furnace combined with a heat exchanger;
separating the dried products and the drying gases at the dryer outlet; and
condensing the drying gases,
wherein uncondensed offgas is injected into the center of a flame maintained in the furnace.
